(19) United States
(12) Patent Application Publication
(10) Pub. No.: US 2003/0074975 A1
(43) Pub. Date: Apr. 24, 2003

(54) Life cycle monitor

(76) Inventor: Oscar Carlson, San Deigo, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/039,778

(22) Filed: Oct. 19, 2001

(51) Int. Cl. G01N 3/00

(52) U.S. Cl. 73/788

(57) ABSTRACT

A system for measuring the stress imparted on an object having a piezoelectric element electrically coupled to a current integrator. The piezoelectric element has first and second electrodes, and the current integrator is a tube filled with mercury having a first end and a second end. First and second electrical contacts are coupled to the first and second electrodes respectively and are inserted into the first and second ends of the tube. An electrolyte gap is contained inside of the mercury in the tube and the mercury is plated across the electrolyte gap in response to the passing of current from the piezoelectric element through the first and second electrical contacts.

### BACKGROUND OF THE INVENTION

The present invention relates to stress measurement devices, and more particularly to a piezo-electric stress measurement system.

Many objects and components of structures are subjected to stresses that are hard to measure because of the nature of the objects and components. For example, an airplane wing is subjected to constant stress during takeoff, landing, and while in-flight. Because of the nature of a wing structure it is hard to inspect stress related damage to all wing components. Currently, the life of a component is often predicted based on the amount of time in service. Often a component is replaced after a given time interval without consideration of the actual stresses endured by the component.

It may be that the component does not need replacing, because the component has not endured a significant amount of stress. Thus, the component may be viable for additional time. In this scenario, components are unnecessarily replaced at a substantial cost.

Alternatively, it may be that a component not near the end of its planned replacement time interval has suffered stress that could lead to premature failure. Premature failure may lead to considerable expense, and in certain situations, injury and loss of life.

Therefore, a means for detecting the cumulative stress endured by an object and component of a structure is desirable. Additionally, it is desirable to measure specific incidents of stress beyond a particular threshold.

### SUMMARY OF THE INVENTION

A system for measuring the stress imparted on an object has a piezoelectric element electrically coupled to a current integrator. In an embodiment, the piezoelectric element is a piezoelectric film. The piezoelectric film may have an adhesive coated upon it for adherence to an object. Additionally, the adhesive may be covered by a removable covering that protects the adhesive prior to application of the piezoelectric film to an object.

In an additional embodiment, the piezoelectric element is coupled to an object for which stress is to be measured using epoxy. The piezoelectric element may also be coupled to an object using anaerobic cement.

In an embodiment of the present invention, the piezoelectric element has first and second electrodes and the current integrator is a mercury filled tube with a first end and a second end. First and second electrical contacts are coupled to the first and second electrodes respectively and inserted into the first and second ends of the tube. The mercury in the tube contains an electrolyte gap and mercury is plated across the electrolyte gap in response to the passing of current through the first and second electrical contacts.

In an additional embodiment of the present invention, a fiber optic thread is inserted into the tube of mercury, the fiber optic thread registering the position of the electrolyte gap within the tube. In yet another embodiment, an optical sensor is positioned outside of the tube, the optical sensor sensing the position of the electrolyte gap within the tube.

In another embodiment, the current integrator is a galvanometer writing on photosensitive paper. Additionally, the current integrator may be a pen writing on moving paper with the position of the pen being altered in response to electrical impulses received from the piezoelectric element.

In another embodiment, the current integrator is a processor and a memory. Each electrical impulse from the piezoelectric element is processed by the processor and saved in the memory. In an additional embodiment, a liquid crystal display is electrically coupled to the processor. The processor controls the liquid crystal display to indicate how much current has been generated by the piezoelectric element. In yet another embodiment, the processor controls the liquid crystal display to only display information about electrical impulses received from the piezoelectric element having a strength higher than a predetermined strength.

In another embodiment, the processor is electrically coupled to a light emitting diode. The processor controls the light emitting diode to indicate how much current has been generated by the piezoelectric element. In yet an additional embodiment, the processor is electrically coupled to an alarm. The processor activates the alarm if a value of the cumulative impulses from the piezoelectric element exceeds a predetermined value. In an embodiment, the alarm is an audio speaker.

In a preferred embodiment, a piezoelectric element and a current integrator are coupled to a package for tracking the amount of stress that the package is subjected to.

### BRIEF DESCRIPTION OF THE DRAWINGS

These and other features of the advantages of the present invention will be better understood by reference to the following detailed description when considered in conjunction with the accompanying drawings wherein:

FIG. 1 is a schematic diagram showing a piezoelectric element coupled to a current integrator in the form of a mercury filled tube according to an embodiment of the present invention;

FIG. 2 is a schematic diagram showing a piezoelectric element having a mechanical attachment coupled to a current integrator in the form of a mercury filled tube according to an embodiment of the present invention;

FIG. 3 is a schematic diagram showing a piezoelectric element coupled to a sensor which is in turn coupled to a display according to an embodiment of the present invention;

FIG. 4 is a schematic diagram showing a piezoelectric element coupled to a processor which is in turn coupled to a liquid crystal display according to an embodiment of the present invention;

FIG. 5 is a schematic diagram showing a piezoelectric element coupled to a processor which is in turn coupled to a light emitting diode according to an embodiment of the present invention;

FIG. 6 is a schematic diagram showing a piezoelectric element coupled to a display according to an embodiment of the present invention; and

FIG. 7 is a schematic diagram showing a piezoelectric element coupled to a processor which is in turn coupled to an alarm according to an embodiment of the present invention.

### DETAILED DESCRIPTION OF THE INVENTION

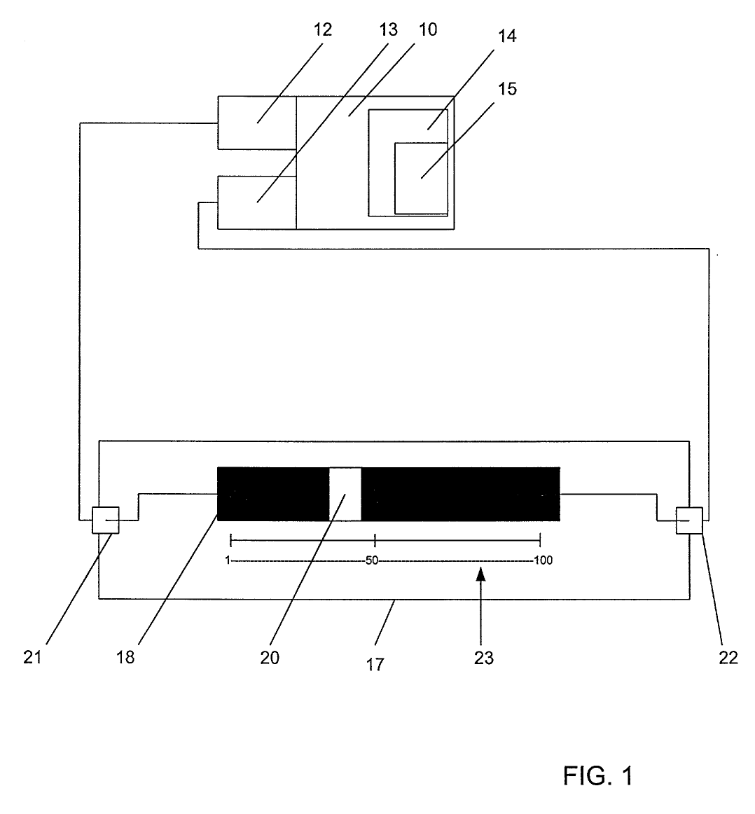

The present invention measures the cumulative force endured by an object, or structural component, to which it is coupled. The system of the present invention, according to an embodiment, as shown in FIG. 1 has a piezoelectric element 10 electrically coupled to a current integrator 17. Piezoelectric elements are known that emit an electrical impulse when subjected to a mechanical stress. Additionally, piezoelectric elements are known that emit an electrical impulse when subjected to a thermal stress. Piezoelectric elements may be incorporated into a variety of packages for attachment to an object or a component for which stress is to be measured.

In one embodiment of the present invention, the piezoelectric element 10 is a piezo film, such as that manufactured by Measurement Specialties, Inc. The piezoelectric element has two electrodes 12, 13. In a further embodiment, the piezoelectric element is coated on one side with an adhesive 14. Once coated, the piezoelectric element may be applied to a variety of components, such as an overnight package. In an additional embodiment, the piezoelectric element adhesive is covered with a removable strip 15 of paper or plastic that is removable by a user when the user elects to apply the piezoelectric element to an object. In yet another alternative embodiment, the piezoelectric element is coupled to an object using epoxy or an anaerobic cement as the adhesive 14.

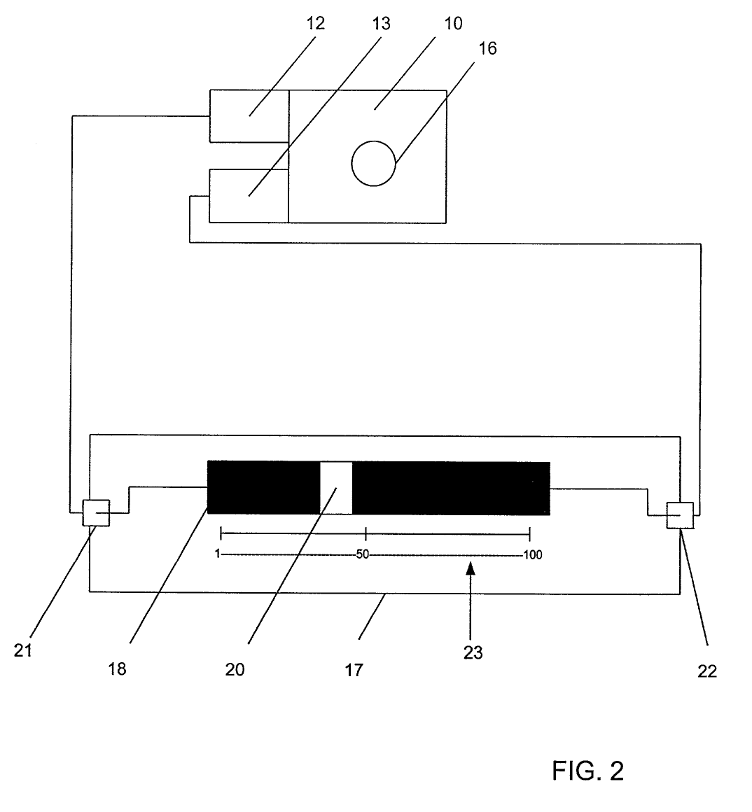

Additionally, an object may be manufactured with the piezoelectric element embedded inside of it or coupled to it. In another embodiment, the piezoelement is manufactured into a packaging for an object, such as a box or an envelope. In yet another embodiment, as shown in FIG. 2, the piezoelectric element is attached to an object or component using mechanical fastening means 16 such as screws, nails, nuts and bolts, and rivets.

As shown in FIGS. 1 and 2, the piezoelectric element is electrically coupled to the integrator 17 for measuring the cumulative output of the piezoelectric element 10. In an embodiment of the present invention, the integrator is a mercury filled tube 18 with an electrolyte gap 20, such as that made by CURTIS, model number 520-LA. The mercury filled tube with an electrolyte gap is a small diameter tube filled with two elements of mercury separated by a column of electrolyte.

The tube has electrical contacts 21, 22 at each end of the tube. The two electrodes 12, 13 of the piezoelectric element are coupled to the two electrical contacts 21, 22. The electrical contacts 21, 22 are submerged in the mercury to provide electrical conductance. As the electrical contacts 21, 22 are subjected to an impulse of electricity from the piezoelectric element, the mercury is plated across the electrolyte and the electrolyte gap moves across the tube. The relative position of the electrolyte in the tube is an indication of the total amount of the electrical impulses from the piezoelectric element and hence the stress experienced by the object to which the piezoelectric element is coupled.

In a specific embodiment, the tube is transparent and visual observation of the position of the electrolyte gap provides an indication of the total amount of electrical impulses from the piezoelectric element. In an additional embodiment, a scale 23 is provided along the length of the tube, the scale being calibrated in relation to the cumulative amount of electrical impulse received from the piezoelectric element.

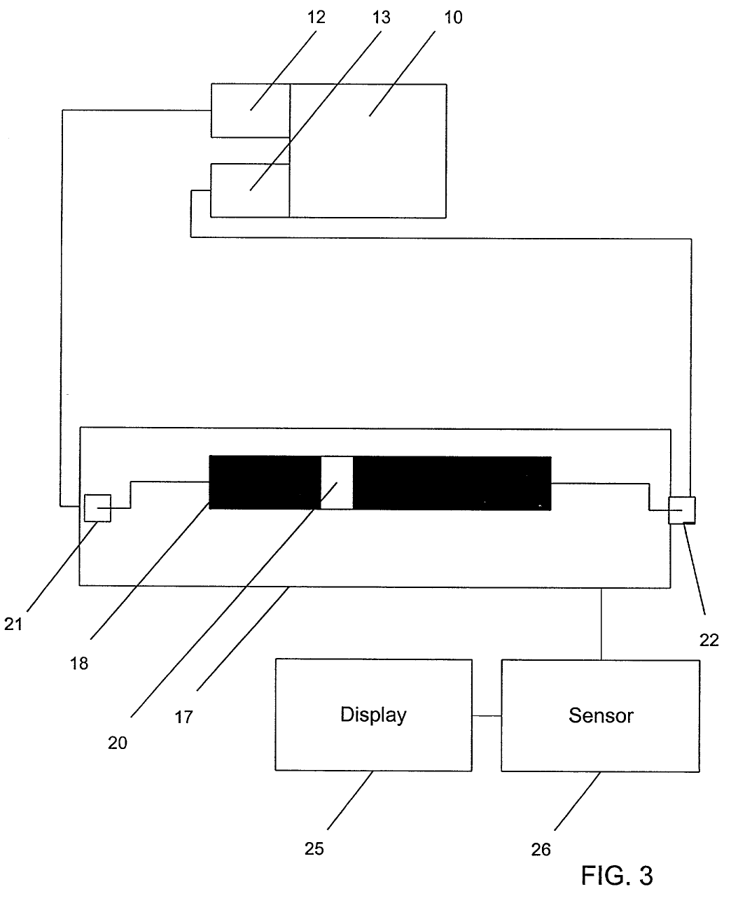

As shown in FIG. 3, the integrator may be coupled to a display 25, so that the amount of stress that the object to which the piezoelectric element is attached is subjected to may be analyzed by a user. In an embodiment of the present invention, a sensor 26, in the form of a fiberoptical thread, is inserted into the mercury for detecting the position of the electrolyte. Alternatively, the position of the electrolyte may be determined by a sensor 26 outside of the mercury filled tube. In an additional embodiment, the sensor 26 is an optical parameter sensing device used to determine the position of the electrolyte along the tube by detecting a change in color, transparency, surface texture, reflectance, and other optical parameters. In yet another embodiment, the sensor 26 determines the position of the electrolyte by measuring an electrical parameter of the tube.

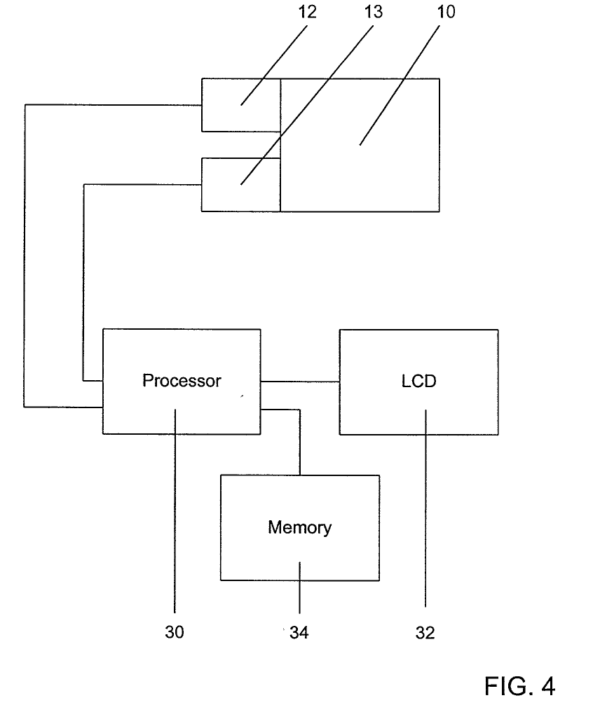

In an alternative embodiment, a liquid crystal display 32 is used to display the output of the piezoelectric element. In this embodiment shown in FIG. 4, the electrodes 12, 13 of the piezoelectric element 10 are electrically coupled to a processor 30, which is in turn electrically coupled to the liquid crystal display 32. The processor may be configured to differentiate and sort electrical impulses from the piezoelectric element by the magnitude of the electrical impulse. The processor may also be configured to output to the liquid crystal display the cumulative number of incidents that generated an electrical impulse above a particular threshold. In an additional embodiment, the processor is electrically coupled to a memory 34. The output of he processor is saved in the memory.

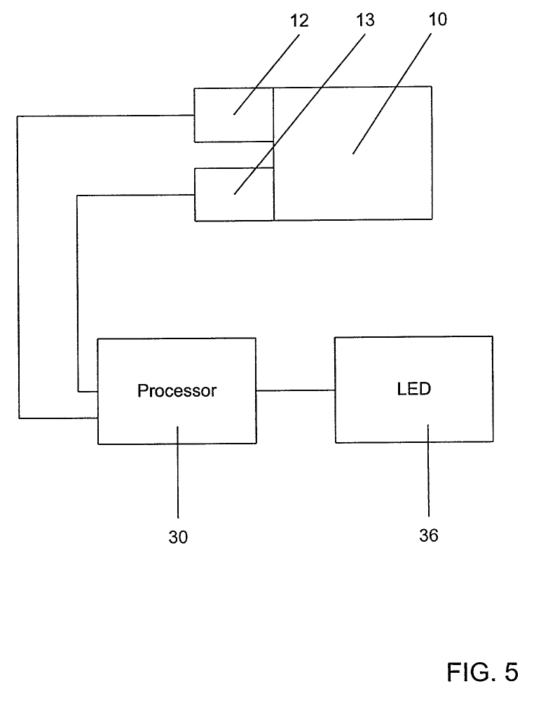

In yet another embodiment, a light emitting diode display is used to display the output of the piezoelectric element. In an embodiment, shown in FIG. 5, the electrodes 12, 13 of the piezoelectric element 10 are electrically coupled to a processor 30, which is in turn electrically coupled to a light emitting diode display 36. In this embodiment, the light emitting diode display is digital and displays the number of stress incidents as a number. In an alternative embodiment, the light emitting diode display is analog and displays the stress as a position on a range, such as a volume unit indicator on an audio amplifier.

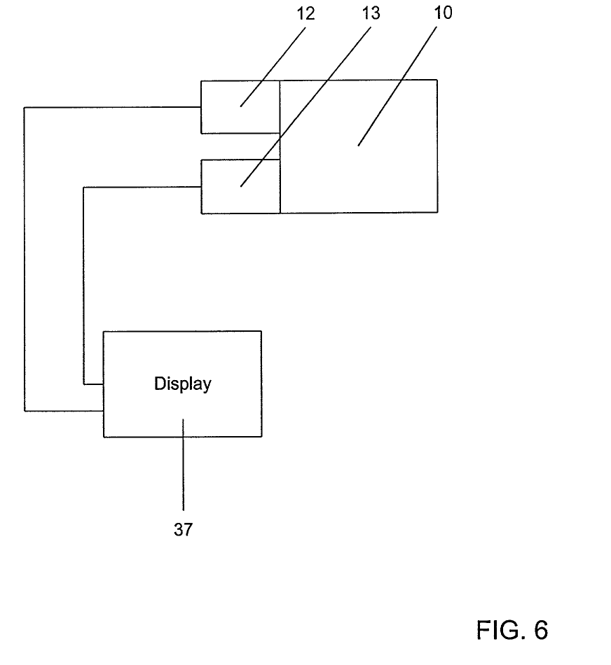

In an additional embodiment, shown in FIG. 6, the piezoelectric element is electrically coupled to a display 37 that shows the amplitude of the stress encountered by the piezoelectric element (and the object or structural component to which it is attached) in relation to time. In a specific embodiment, the display 37 is an oscilloscope. In another specific embodiment, the display 37 is a ballistic galvanometer writing on a photosensitive paper. In yet another specific embodiment, the display 37 is a pen writing on moving paper, the pen being moved in response to an electrical impulse either received from the piezoelectric element or by an amplifier amplifying the signal from the piezoelectric element. In another specific embodiment, the display 37 is a computerized display that correlates each stress incident in terms of amplitude, frequency and time.

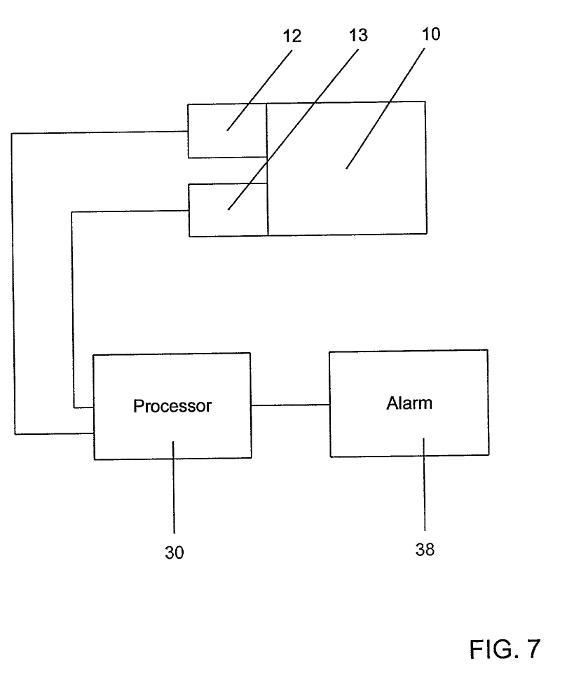

Additionally, as shown in FIG. 7, the piezoelectric element 10 may be electrically coupled to a processor 30 which may in turn be electrically coupled to an alarm 38. In a specific embodiment, the processor is configured to activate the alarm if the object to which the piezoelectric element is attached is subjected to a single stress having a magnitude above a predetermined threshold. In an additional embodiment, the processor is configured to activate the alarm if the value of the cumulative electrical impulses received from the piezoelectric element is above a predetermined value. In an embodiment, the alarm is a speaker that is energized by the processor so as to emit a loud sound. In an alternative embodiment, the alarm is a panel that changes color upon having a current passed through it.

The preceding description has been presented with reference to presently preferred embodiments of the invention. Workers skilled in the art and technology to which this invention pertains will appreciate that alterations and changes in the described product and method may be practiced without meaningfully departing from the principles, spirit and scope of this invention. Accordingly, the foregoing description and accompanying drawings should not be read as pertaining only to the precise products and methods described, but rather should be read consistent with and as support to the following claims which are to have their fullest and fair scope.

What is claimed is:

1. A system for measuring the stress imparted on an object comprising:
a piezoelectric element; and
a current integrator electrically coupled to the piezoelectric element.

2. The system for measuring stress of claim 1 wherein the piezoelectric element is a piezoelectric film.

3. The system for measuring stress of claim 2 wherein the piezoelectric film further comprises an adhesive.

4. The system for measuring stress of claim 3 wherein the adhesive is covered by a removable covering.

5. The system for measuring stress of claim 1 further comprising adhesive for coupling the piezoelectric element to an object.

6. The system for measuring stress of claim 1 further comprising at least one of the group consisting of epoxy and anaerobic cement for coupling the piezoelectric element to an object.

7. The system for measuring stress of claim 1 wherein the current integrator is a galvanometer writing on photosensitive paper.

8. The system for measuring stress of claim 1 wherein the current integrator is a pen writing on moving paper wherein the position of the pen is altered in response to an electrical impulse from the piezoelectric element.

9. The system for measuring stress of claim 1 wherein the current integrator comprises a processor and a display electrically coupled to the piezoelectric element; wherein an electrical signal from the piezoelectric element is processed by the processor and displayed on the display.

10. The system for measuring stress of claim 9 further comprising a memory electrically coupled to the processor.

11. The system for measuring stress of claim 1 wherein:
the piezoelectric element comprises first and second electrodes; and
the current integrator comprises:
a tube having a first end and a second end, the tube being filled with mercury;
first and second electrical contacts, the first electrical contact being coupled to the first electrode of the piezoelectric element and inserted into the first end of the tube, the second electrical contact being coupled to the second electrode of the piezoelectric element and inserted into the second end of the tube; and
an electrolyte gap inside of the mercury in the tube;
wherein the mercury is plated across the electrolyte gap in response to the passing of a current through the first and second electrical contacts.

12. The system for measuring stress of claim 11 further comprising a fiber optic thread inserted into the tube of mercury; wherein the fiber optic thread registers the position of the electrolyte gap within the tube.

13. The system for measuring stress of claim 11 further comprising an optical sensor positioned outside of the tube; wherein the optical sensor senses the position of the electrolyte gap within the tube.

14. A system for measuring stress comprising a piezoelectric element and a processor electrically coupled to the piezoelectric element; wherein the processor processes electrical impulses generated by the piezoelectric element.

15. The system for measuring stress of claim 14 further comprising a liquid crystal display electrically coupled to the processor; wherein the processor controls the liquid crystal display to indicate how much current has been generated by the piezoelectric element.

16. The system for measuring stress of claim 15 wherein the processor controls the liquid crystal display to only display information about electrical impulses having a strength higher than a predetermined strength.

17. The system for measuring stress of claim 14 further comprising a light emitting diode electrically coupled to the processor; wherein the processor controls the light emitting diode to indicate how much current has been generated by the piezoelectric element.

18. The system for measuring stress of claim 14 further comprising an alarm electrically coupled to the processor; wherein the processor activates the alarm if a cumulative value of the impulses from the piezoelectric element exceeds a predetermined value.

19. The system for measuring stress of claim 18 wherein the alarm is an audio speaker.

20. A method for measuring the stress encountered by a package comprising the steps of:
coupling a piezoelectric element to a package;
coupling a current integrator to the package;
electrically coupling the piezoelectric element to the current integrator.
